(19) United States
(12) Patent Application Publication
(10) Pub. No.: US 2011/0074782 A1
(43) Pub. Date: Mar. 31, 2011

(54) IMAGE DISPLAY APPARATUS, METHOD, AND STORAGE MEDIUM

(75) Inventors: Takayuki HIROTANI, Tokyo (JP); Keiichi Sakurai, Tokyo (JP)

(73) Assignee: CASIO COMPUTER CO., LTD., Tokyo (JP)

(21) Appl. No.: 12/887,741

(22) Filed: Sep. 22, 2010

(30) Foreign Application Priority Data
Sep. 29, 2009 (JP) 2009-224009

(51) Int. Cl. G06T 15/80; G09G 5/02

(52) U.S. Cl. 345/426; 345/589

(57) ABSTRACT

An image capturing unit 22 of an apparatus captures an image of a viewer 11 viewing a display image displayed in a display unit 21. The apparatus detects a face of the viewer 11 from the captured image. The apparatus determines a position of the face thus detected and a position of a light source 12, respectively. The apparatus detects a reflection area 61 from the display image (including a clock object 31) based on the positions of the face and the light source. Subsequently, the apparatus executes, on data of the display image, the image processing of adding a reflection effect to the reflection area. Then, the apparatus causes the display unit 21 to display the display image based on the data on which the image processing has been executed.

This application is based upon and claims the benefit of priority from the prior Japanese Patent Application No. 2009-224009, filed Sep. 29, 2009, and the entire contents of which are incorporated herein by reference.

### BACKGROUND OF THE INVENTION

1. Field of the Invention

The present invention relates to an image processing technology, and more particularly to an image display apparatus, a method, and a storage medium capable of presenting realistic and natural images to a viewer.

2. Related Art

Conventionally, there is an image processing technique for presentation of three-dimensional (hereinafter simply referred to as “3D”) effects by adding reflection light and shading to images (see Japanese Patent Application Publication No, 2007-328460, for example).

### SUMMARY OF THE INVENTION

However, according to the conventional image processing technique, the presence of a viewer who is supposed to see the images has not been considered when adding reflection light and shading to images. Accordingly, images to which 3D effects are added using the conventional image processing technique are often recognized as unrealistic and unnatural images to the viewer, due to the reflection light or the shading that are shown not relating to the actual environment.

Thus, the present invention was conceived in view of the above problem, and it is an object of the present invention to provide realistic and natural images to the viewer.

According to a first aspect of the present invention, there is provided an image display apparatus comprising: an image capturing unit that captures an image of a viewer viewing a display image displayed in a display unit; a face detecting unit that detects a face from the image captured by the image capturing unit; a face position determining unit that determines a position of the face detected by the face detecting unit; a light source position determining unit that determines a position of a light source; a reflection area detecting unit that detects a reflection area from the display image based on the position of the face determined by the face position determining unit and the position of the light source determined by the light source position determining unit, the reflection area being an area in which light incident from the light source is reflected toward the face; a reflection effect processing unit that executes, on data of the display image, the image processing of adding a reflection effect to the reflection area detected by the reflection area detecting unit; and a display control unit that causes the display unit to display the display image based on the data on which the image processing has been executed by the reflection effect processing unit.

According to a second aspect of the present invention, there is provided an image display method comprising: an image capturing control step of controlling image capturing to capture an image of a viewer viewing a display image displayed in a display unit; a face detecting step of detecting a face from the image captured in the image capturing control step; a face position determining step of determining a position of the face detected in the face detecting step; a light source position determining step of determining a position of a light source; a reflection area detecting step of detecting a reflection area from the display image based on the position of the face determined in the face position determining step and the position of the light source determined in the light source position determining step, the reflection area being an area in which light incident from the light source is reflected toward the face; a reflection effect processing step of executing, on data of the display image, image processing of adding a reflection effect to the reflection area detected in the reflection area detecting step; and a display control step of causing the display unit to display the display image based on the data on which the image processing has been executed in the reflection effect processing step.

According to a first aspect of the present invention, there is provided a storage medium storing a program readable by a computer for controlling image processing to cause the computer to execute a control process, comprising: an image capturing control step of controlling image capturing to capture an image of a viewer viewing a display image displayed in a display unit; a face detecting step of detecting a face from the image captured in the image capturing control step; a face position determining step of determining a position of the face detected in the face detecting step; a light source position determining step of determining a position of a light source; a reflection area detecting step of detecting a reflection area from the display image based on the position of the face determined in the face position determining step and the position of the light source determined in the light source position determining step, the reflection area being an area in which light incident from the light source is reflected toward the face; a reflection effect processing step of executing, on data of the display image, image processing of adding a reflection effect to the reflection area detected in the reflection area detecting step; and a display control step of causing the display unit to display the display image based on the data on which the image processing has been executed in the reflection effect processing step.

### BRIEF DESCRIPTION OF THE DRAWINGS

FIG. 1 is an elevational view illustrating an external configuration of a digital photo frame constituting an image display apparatus according to one embodiment of the present invention;

FIG. 2 is a functional block diagram showing a functional configuration of the digital photo frame shown in FIG. 1;

FIG. 3 is an elevational view showing an external configuration of the digital photo frame shown in FIG. 1, in a case in which a light source is a virtual light source;

FIG. 4 is a top view showing an external configuration of the digital photo frame shown in FIG. 1, illustrating an example of processing carried out by the light source face angle calculating unit;

FIG. 5 is a top view showing an external configuration of the digital photo frame shown in FIG. 1, illustrating an example of processing carried out by the reflection effect processing unit;

FIG. 6 is a block diagram showing a hardware configuration of the digital photo frame shown in FIG. 1;

FIG. 7 is a flowchart showing one example of a flow of the image display processing carried out by the digital photo frame shown in FIG. 1;

FIG. 8 is a top view showing an external configuration of a digital photo frame constituting an image display apparatus according to a modified embodiment of the present invention; and

FIG. 9 is a diagram illustrating a reflection effect and a shading effect rendered by the digital photo frame shown in FIG. 8.

### DETAILED DESCRIPTION OF THE INVENTION

The following describes an embodiment of the present invention with reference to the drawings.

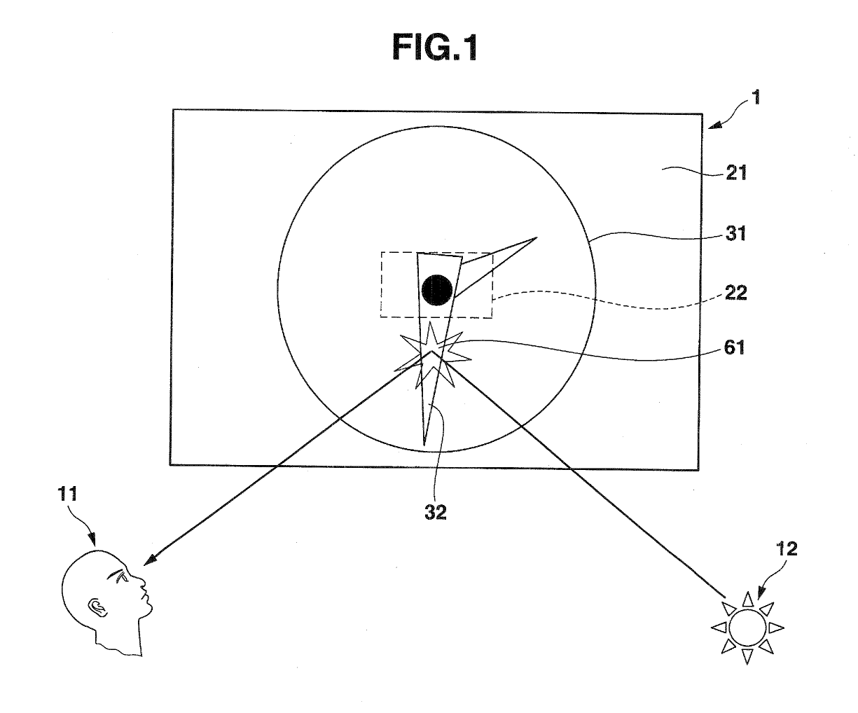

An image display apparatus according to the present invention can be configured by a digital photo frame, a personal computer, or the like, for example. In the following description, a case in which the image display apparatus is configured by a digital photo frame 1 is described. FIG. 1 is an elevational view illustrating an external configuration of the digital photo frame 1.

In front of the digital photo frame 1, a display unit 21 is provided that is configured by a liquid crystal display or the like, for example. In the present embodiment, an image displayed in the display unit 21 (hereinafter referred to as the “display image”) includes a clock object 31. Accordingly, a viewer 11 viewing the display image in the digital photo frame 1 can notice the present time by looking at the clock object 31 displayed in the display unit 21.

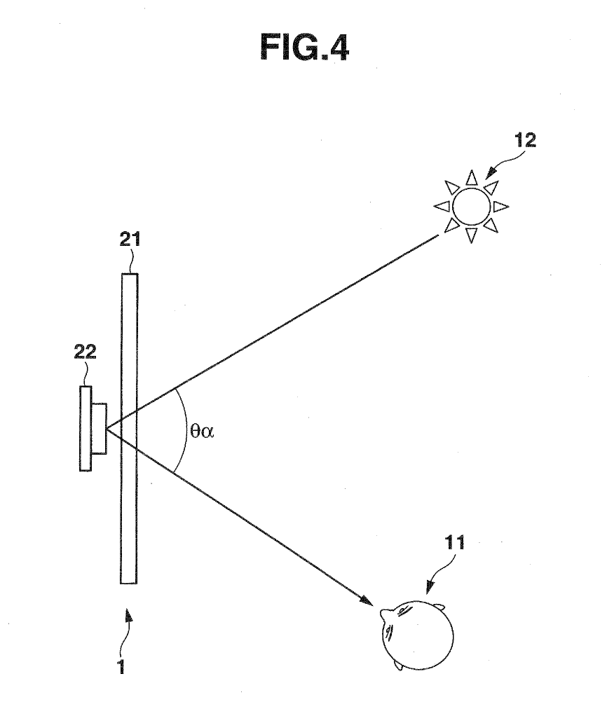

Furthermore, the digital photo frame 1 is provided with an image capturing unit 22 configured by a digital camera or the like, for example. The image capturing unit 22 captures images that are present within an angle of view with respect to a forward direction from a front surface of the digital photo frame 1 (a display screen of the display unit 21). Hereinafter, an image that is captured by the image capturing unit 22 is referred to as the “captured image”. In other words, the image capturing unit 22 captures images of places at which the viewer 11 viewing the display unit 21 can be present as captured images, and outputs image data of the captured images. In the present embodiment, as will be later described with reference to FIG. 4, a description is provided given assuming that the image capturing unit 22 is located on a back side of the display unit 21 so that an image of the viewer viewing the display image can be captured from a center of the display unit 21; however, the arrangement position thereof is not particularly limited, and the image capturing unit 22 may be located outside a display range of the display unit 21.

The digital photo frame 1 attempts to detect a face of the viewer 11 included in the captured image based on the image data outputted from the image capturing unit 22. Here, in a case in which a face is detected, the digital photo frame 1 determines information for specifying a position of the face, e.g., information relating to a distance and a direction to the face with reference to the image capturing unit 22. The information for specifying the position of the face thus obtained is hereinafter referred to as the “face position”. Here, it is preferred that a range of positions at which the face of the viewer 11 is possibly present in order to see the clock object 31 has been previously estimated, and the image capturing unit 22 is designed to be able to sufficiently capture images within the estimated range. In the present embodiment, a description is provided using the clock object 31 as an object; however, the object is not limited to the clock object 31.

Furthermore, the digital photo frame 1 determines information for specifying a position of a light source 12, e.g., information relating to a distance and a direction to the light source 12 with reference to the image capturing unit 22. The information for specifying the position of the light source 12 thus obtained is hereinafter referred to as the “light source position”. In the present embodiment, an actual light source and a virtual light source can be selectively employed as the light source 12. Accordingly, although how to determine the light source position is different depending upon the actual light source and the virtual light source, a specific example of each case will be described later.

Next, the digital photo frame 1 detects an area (hereinafter referred to as the “reflection area”) in which light entering from the light source 12 is expected to be reflected toward the face of the viewer 11 from the display image, based on the face position and the light source position that have been detected. Then, the digital photo frame 1 executes image processing of adding an rendered effect (hereinafter referred to as the “reflection effect”) so as to look as if light were reflected in the reflection area, to image data of the display image, for example, by increasing luminance of the reflection area or such. Moreover, the digital photo frame 1 detects an area (hereinafter referred to as the “shaded area”) that the viewer 11 would recognize as shading from the display image excluding the reflection area, based on the face position and the light source position that have been detected. Then, the digital photo frame 1 executes image processing of adding a rendered effect (hereinafter referred to as the “shading effect”) so as to look as if light were not reflected to the shaded area and there were shading, to the image data of the display image, for example, by decreasing luminance of the shaded area or such.

The digital photo frame 1 displays the display image on the display unit 21 based on the image data thus generated by executing the image processing. The display image thus obtained is presented, according to the actual environment of the viewer 11, as an image that looks as if the reflection light (or diffusion light) were present in the reflection area and the shading were present in the shaded area. For example, in the example shown in FIG. 1, a partial area 61 of a long hand 32 of the clock object 31 is detected as the reflection area, and the reflection light (or diffusion light) is displayed. In this manner, the digital photo frame 1 is able to display a realistic and natural image for the viewer 11 as the display image in the display unit 21.

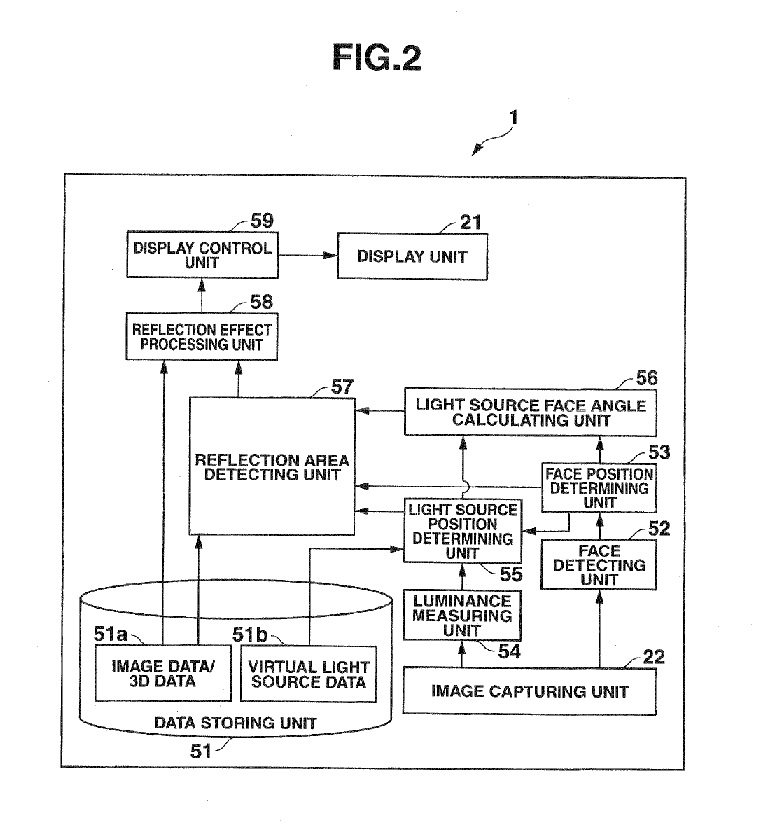

FIG. 2 is a functional block diagram illustrating an example of a functional configuration of the digital photo frame 1. Referring to FIG. 2, the functional configuration of the digital photo frame 1 according to the present embodiment is described.

More specifically, the digital photo frame 1 is provided with, in addition to the display unit 21 and the image capturing unit 22 as described above, a data storing unit 51, a face detecting unit 52, a face position determining unit 53, a luminance measuring unit 54, a light source position determining unit 55, a light source face angle calculating unit 56, a reflection area detecting unit 57, a reflection effect processing unit 58, and a display control unit 59.

The data storing unit 51 stores the image data of the display image and 3D data which is 3D information of the display image (hereinafter integrally referred to as the data of the display image). In the present embodiment, for example, data of each component such as the long hand 32 that constitutes the clock object 31 shown in FIG. 1 is also stored in the data storing unit 51. Furthermore, data that is able to specify such as a type and the position of the virtual light source (hereinafter referred to as the virtual light source data) are also stored in the data storing unit 51.

The face detecting unit 52 attempts to detect a face of a person included in the captured image based on the image data outputted from the image capturing unit 22. If one or more persons' faces are detected, the detection result of the face detecting unit 52 is supplied to the face position determining unit 53. The face position determining unit 53 sets a predetermined one of the one or more faces that have been detected by the face detecting unit 52 as a face-to-be-processed. The face position determining unit 53 determines a position of the face-to-be-processed that has been thus set. In the example shown in FIG. 1, since the viewer 11 is just one, the face of the viewer 11 is the face-to-be-processed, and the face position determining unit 53 determines the face position of the face of the viewer 11. The face position that has been determined by the face position determining unit 53 is supplied to the light source position determining unit 55, the light source face angle calculating unit 56, and the reflection area detecting unit 57.

The luminance measuring unit 54 measures luminance distribution of the captured image based on the image data outputted from the image capturing unit 22. Information of the luminance distribution that has been measured by the luminance measuring unit 54 is supplied to the light source position determining unit 55 along with the image data of the captured image.

The light source position determining unit 55 acquires the virtual light source data from the data storing unit 51 when employing the virtual light source. Furthermore, the light source position determining unit 55 determines the light source position of the virtual light source based on the virtual light source data.

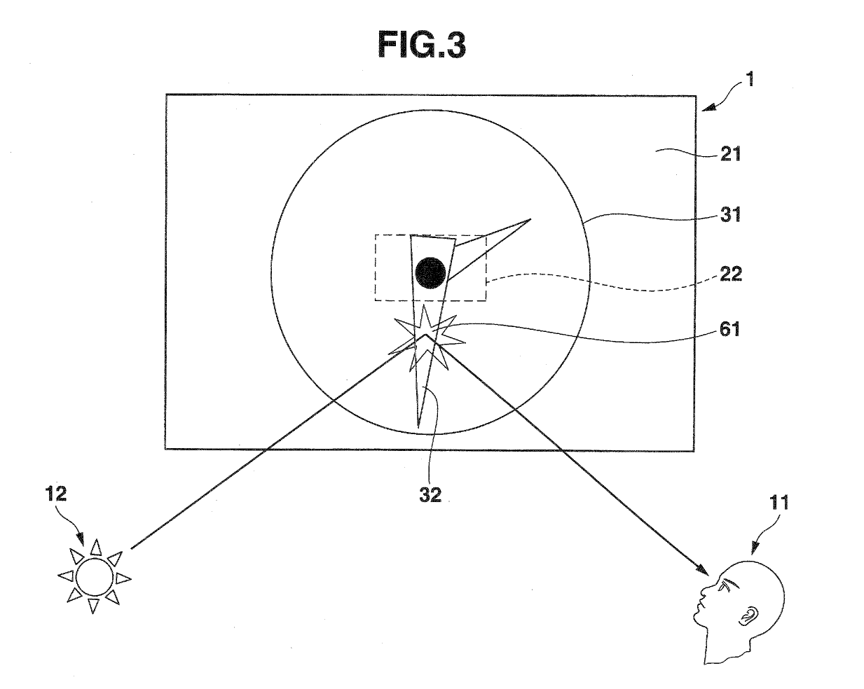

In the present embodiment, as shown in FIG. 1, when the face of the viewer 11 is present on the left side in the figure centering the display unit 21, the light source position is determined such that the light source 12, which is the virtual light source, is positioned on the right side in the figure centering the display unit 21. In contrast, as shown in FIG. 3, when the face of the viewer 11 is present on the right side in the figure centering the display unit 21, the light source position is determined such that the light source 12, which is the virtual light source, is positioned on the left side in the figure centering the display unit 21. In order to add the reflection effect and the shading effect that are preferable to the viewer 11, it is considered to be preferable for the light source position of the virtual light source to be determined based on the position of the face of the viewer 11. The determination of the light source position of the virtual light source is not limited to the method based on the virtual light source data. According to the present invention, it is possible to carry out the image processing by setting the light source position at any position or in any direction depending on the implementation.

Referring back to FIG. 2, the light source position determining unit 55 acquires the information of the luminance distribution that has been measured by the luminance measuring unit 54, when employing the actual light source. The light source position determining unit 55 determines an area with luminance of a level no smaller than a predetermined level in the captured image as the actual light source based on the information of the luminance distribution. Then, the light source position determining unit 55 determines the light source position of the actual light source based on the image data of the captured image.

The light source position thus determined by the light source position determining unit 55 is supplied to the light source face angle calculating unit 56 and the reflection area detecting unit 57.

The light source face angle calculating unit 56 calculates an angle θα formed by, as shown in FIG. 4, a straight line passing the face-to-be-processed (the face of the viewer 11 in the example shown in FIG. 4) and the image capturing unit 22 and a straight line passing the light source 12 and the image capturing unit 22 (hereinafter referred to as the “face light source angle θα”), for example. The face light source angle θα is calculated based on the face position determined by the face position determining unit 53 shown in FIG. 2, the light source position determined by the light source position determining unit 55, and an angle of view of the image capturing unit 22. The face light source angle θα is supplied from the light source face angle calculating unit 56 to the reflection area detecting unit 57.

The reflection area detecting unit 57 acquires the data of the display image from the data storing unit 51. Furthermore, the reflection area detecting unit 57 acquires the face light source angle θα from the light source face angle calculating unit 56, acquires the face position from the face position determining unit 53, and acquires the light source position from the light source position determining unit 55. Then, the reflection area detecting unit 57 detects the reflection area in the display image based on the various data thus acquired.

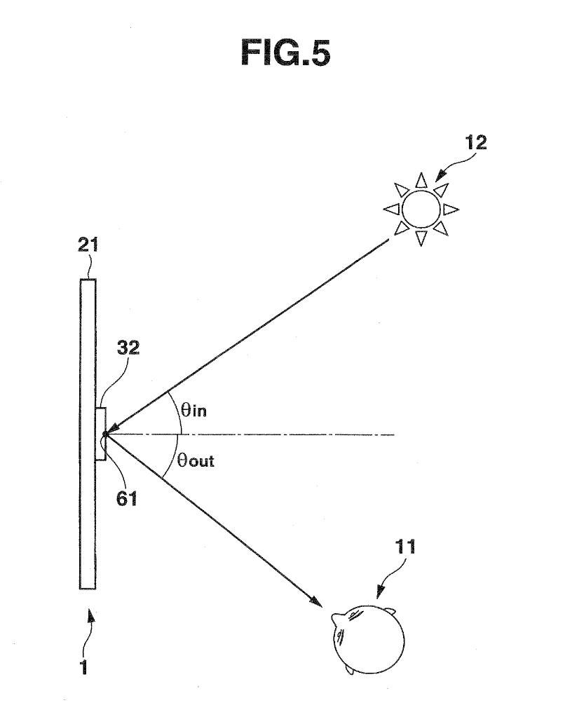

In the present embodiment, for the sake of ease of explanation, a description is provided assuming that a surface of the clock object 31 is a flat surface without irregularity, and that the reflection effect is added only to the hand of the clock object 31. In this case, as shown in FIG. 5, for example, the reflection area detecting unit 57 obtains an estimated incident angle θin of the light entering from the light source 12 and a reflection angle θout of this light (=the incident angle θin), for each of the areas that constitute the display image. Then, the reflection area detecting unit 57 detects, as the reflection area, an area in which the face light source angle θα is approximately twice as large as the reflection angle θout (an angle substantially equal to the incident angle θin +the reflection angle θout), out of the areas that constitute the hand of the clock object 31 of the display image, for example. In the example shown in FIG. 5, the partial area 61 of the long hand 32 of the clock object 31 is detected as the reflection area. The method of detecting the reflection area is not particularly limited to the method according to the present embodiment, and can be any preferred method depending on the implementation, such as correcting the face light source angle θα on the basis of the distance from the image capturing unit 22 to each area of the display image, for example.

Referring back to FIG. 2, the reflection area detecting unit 57 further detects a predetermined area from the display image excluding the detected reflection area as the shaded area. The information for specifying the reflection area and the shaded area detected by the reflection area detecting unit 57 is supplied as the detection result of the reflection area detecting unit 57 to the reflection effect processing unit 58.

The reflection effect processing unit 58 acquires the data of the display image from the data storing unit 51. The reflection effect processing unit 58 executes the image processing of adding the reflection effect to the reflection area and the image processing of adding the shading effect to the shaded area, based on the detection result of the reflection area detecting unit 57, on the data of the display image. The data of the display image to which the reflection effect and the shading effect are added is supplied to the display control unit 59.

The display control unit 59 displays the display image to which the reflection effect and the shading effect are added in the display unit 21 based on the data supplied from the reflection effect processing unit 58. In the example shown in FIG. 1, the partial area 61 of the long hand 32 of the clock object 31 is displayed with the reflection effect as the reflection area. As a result, the viewer 11 is able to see the appearance of light reflecting on the partial area 61 of the long hand 32 of the clock object 31. Furthermore, although not shown in FIG. 1, the remaining part of the clock object 31 is displayed, for example, with the shading effect as the shaded area. As a result, the viewer 11 is able to see an appearance in which there is shading in the shaded area of the clock object 31. Furthermore, although not show in the drawings, since the long hand 32 of the clock object 31 moves rotationally as time passes, there is time of day at which the face light source angle as does not match the angle substantially twice as large as the reflection angle θout in the areas that constitute the long hand 32 of the display image. During such a time of day, the reflection area is not detected, and the long hand 32 is displayed without the reflection effect being added. Accordingly, the viewer 11 is able to see an appearance in which the light is reflected or not reflected on the long hand 32 depending on the time of day. Furthermore, although not shown in the drawings, the viewer 11 is able to see such an appearance also for the short hand or the second hand. In this manner, a realistic and natural image for the viewer 11 is displayed in the display unit 21 as the display image.

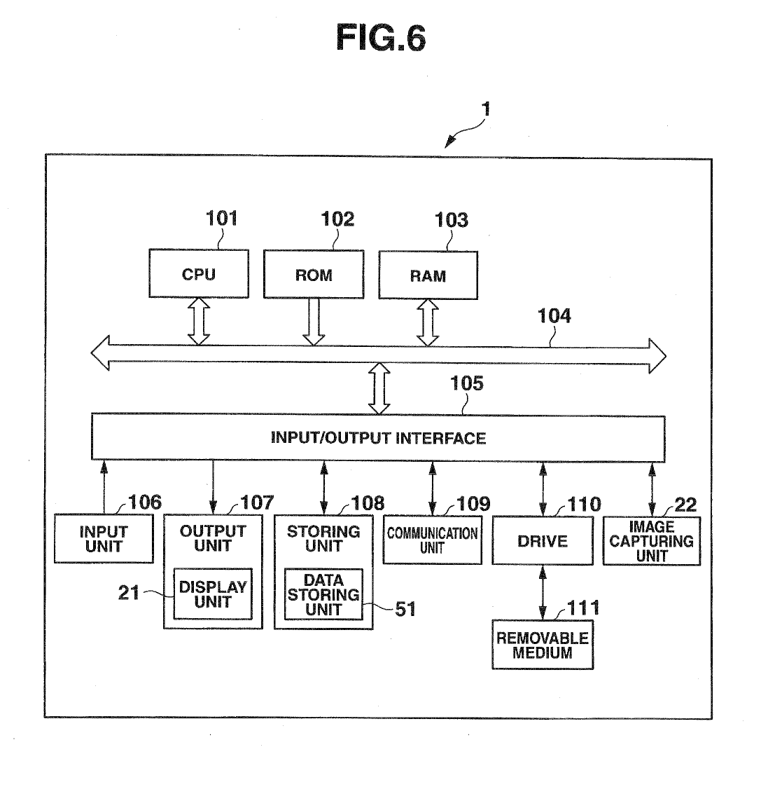

FIG. 6 is a block diagram illustrating an example of a hardware configuration of the digital photo frame 1.

The digital photo frame 1 is provided with a CPU (Central Processing Unit) 101, ROM (Read Only Memory) 102, RAM (Random Access Memory) 103, a bus 104, an input/output interface 105, an input unit 106, an output unit 107, a storing unit 108, a communication unit 109, a drive 110, and the image capturing unit 22 described above.

The CPU 101 executes various processes according to programs that are recorded in the ROM 102. Alternatively, the CPU 101 executes various processes according to programs that are loaded from the storing unit 108 to the RAM 103. The RAM 103 also stores data and the like necessary for the CPU 101 to execute the various processes appropriately.

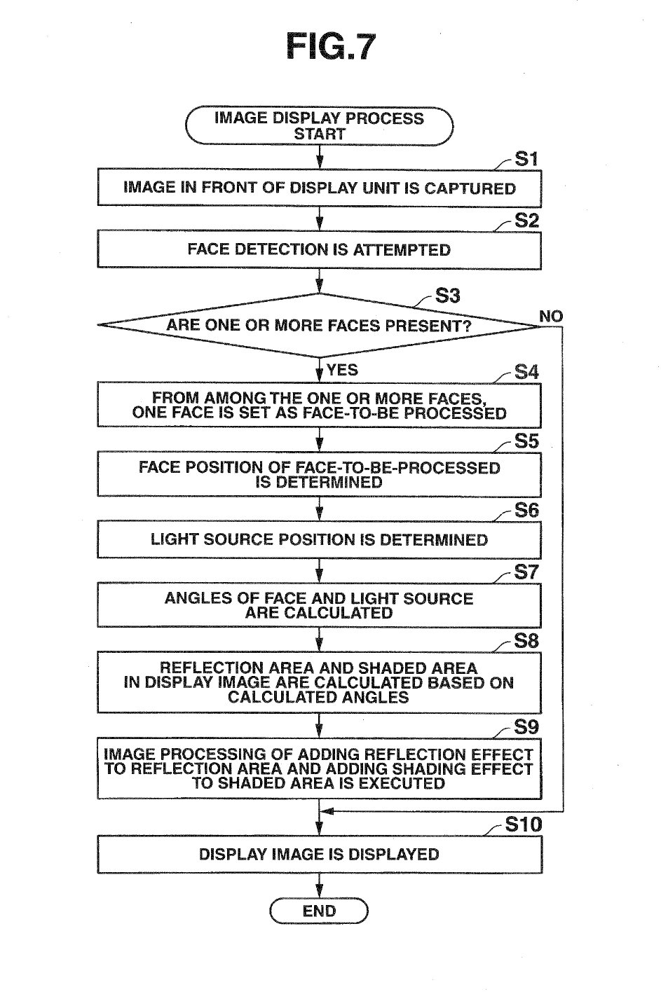

For example, according to the present embodiment, programs for executing the functions of the face detecting unit 52 to the display control unit 59 shown in FIG. 2 are stored either in the ROM 102 or in the storing unit 108. Therefore, each of the functions of the face detecting unit 52 to the display control unit 59 can be realized by the CPU 101 executing the processes according to these programs. Hereinafter, the processes executed according to the programs are referred to as an image display process. One example of the image display process will be described later with reference to the flowchart of FIG. 7.

The CPU 101, the ROM 102, and the RAM 103 are connected to each other via the bus 104. The bus 104 is also connected with the input/output interface 105.

The input unit 106, the output unit 107 including the display unit 21 shown in FIG. 2, and the storing unit 108 constituted by a hard disk and such are connected to the input/output interface 105. The storing unit 108 includes the data storing unit 51 shown in FIG. 2. The input/output interface 105 is also connected with the communication unit 109 constituted by a modem, a terminal adapter, or the like, and the image capturing unit 22 shown in FIG. 2. The communication unit 109 controls communication with other devices (not shown) via a network including the Internet.

The input/output interface 105 is also connected with the drive 110 as needed, and a removable medium 111 constituted as a magnetic disk, an optical disk, a magnetic optical disk, or semiconductor memory is loaded accordingly. Then, the programs read from these devices are installed in the storing unit 108 as needed. The removable medium 111 can also stores various data such as the image data and the 3D data that are stored in the data storing unit 51 in the example shown in FIG. 2.

FIG. 7 is a flowchart showing one example of a flow of the image display process by the digital photo frame 1 shown in FIG. 6.

In Step S1, the CPU 101 controls the image capturing unit 22 and captures an image in front of the display unit 21. More specifically, in the example shown in FIG. 1, the captured image including the viewer 11, as well as the light source 12 in a case of the light source 12 being actual light source, is captured, for example.

In Step S2, the CPU 101 attempts to detect a face of the person included in the captured image based on the image data outputted from the image capturing unit 22.

In Step S3, the CPU 101 judges whether or not one or more faces are present.

In a case in which no face has been detected in the process of Step S2, or all of the faces that have been detected in the process of Step S2 are determined to be positioned at distances farther than a predetermined distance (for example, in a case in which areas of all of the faces are no greater than a predetermined area), it is judged to be NO in the process of Step S3. As a result, the process proceeds to Step S10 without executing the processes of Steps S4 to S9 that will be later described, i.e. without executing the image processing of adding the reflection effect or the shading effect. In Step S10, the CPU 101 causes the display unit 21 to display the display image to which the reflection effect or the shading effect is not added. With this, the image display process ends.

In contrast, in a case in which one or more faces are detected within the predetermined distance in the process of Step S2 (for example, the areas of the one or more faces are greater than the predetermined area), it is judged to be YES in the process of Step S3, and the process proceeds to Step S4. More specifically, for example, in the example shown in FIG. 1, as the face of the viewer 11 is detected, it is judged to be YES in the process of Step S3, and the process proceeds to Step S4.

In Step S4, the CPU 101 sets one of the one or more faces as the face-to-be-processed. Specifically, in a case in which a plurality of faces is detected, it is extremely difficult to add the reflection effect and the shading effect appropriately to all of the plurality of faces. Accordingly, the CPU 101 sets a predetermined one of the plurality of faces as the face-to-be-processed. The CPU 101 executes the processes of Step S5 and thereafter so that the reflection effect and the shading effect are appropriately added to the face-to-be-processed thus set. The method of selecting one of the plurality of faces as the face-to-be-processed is not particularly limited, and can be determined depending on the implementation from such as, for example, a method of selecting a face detected in the center of the image by the face detecting unit 52 as the face-to-be-processed, and a method of selecting the user's face whose features are previously stored as the face-to-be-processed. The description of the example shown in FIG. 1 is continued assuming that the face of the viewer 11 is selected as the face-to-be-processed.

In Step S5, the CPU 101 determines the face position of the face-to-be-processed. More specifically, for example, in the example shown in FIG. 1, the position of the face of the viewer 11 is determined based on the data of the captured image that has been captured in the process of Step S1.

In Step S6, the CPU 101 determines the light source position. As described above, the virtual light source and the actual light source are selectively employed in the present embodiment, and how to determine the light source position is different depending on which type is selected as the light source. More specifically, for example, in the example shown in FIG. 1, the light source position of the light source 12 is determined.

In Step S7, the CPU 101 calculates angles of the face and the light source based on the angle of view of the image capturing unit 22, the face position, and the light source position. More specifically, for example, as shown in FIG. 4, the face light source angle θα is calculated.

In Step S8, the CPU 101 detects the reflection area and the shaded area in the display image based on the angles that have been calculated. Here, the estimated incident angle θin of the light entering from the light source 12 and the reflection angle θout (=the incident angle θin) are obtained for each of the areas that constitute the hand of the clock object 31 of the display image. Then, at this point, the area of the hand in the display image, in which the face light source angle θα is substantially twice as large as the reflection angle θout (the angle substantially equal to the incident angle θin+the reflection angle θout), is detected as the reflection area. In the example shown in FIG. 5, the partial area 61 of the long hand 32 of the clock object 31 is detected as the reflection area. Furthermore, the predetermined area from the display image excluding the detected reflection area is detected as the shaded area.

In Step S9, the CPU 101 executes the image processing of adding the reflection effect to the reflection area and the image processing of adding the shading effect to the shaded area on the data of the display image.

In Step S10, the CPU 101 causes the display unit 21 to display, based on the image data on which the image processing of Step S9 has been executed, the image in which the reflection effect is added to the reflection area and the shading effect is added to the shaded area as the display image. More specifically, for example, in the example shown in FIG. 1, the partial area 61 of the long hand 32 of the clock object 31 is displayed as the reflection area with the reflection effect being added. Furthermore, although not shown in the drawings, for example, another part of the clock object 31 is displayed as the shaded area with the shading effect being added.

With this, the image display process ends.

As described above, the image display apparatus according to the present embodiment detects the face of the viewer from the captured image and determines the face position of the face. Furthermore, the image display apparatus according to the present embodiment determines the light source position of the virtual light source or the actual light source. Then, the image display apparatus according to the present embodiment detects the reflection area and the shaded area in the display image based on the face position and the light source position that have been determined. The image display apparatus according to the present embodiment executes the image processing of adding the reflection effect to the reflection area thus detected and the shading effect to the shaded area thus detected to the image data of the display image. With this, the image display apparatus according to the present embodiment is able to display an image in which the reflection effect is added to the reflection area and the shading effect is added to the shaded area as the display image. Specifically, the image display apparatus according to the present embodiment is able to display a realistic image to the viewer.

It should be noted that the present invention is not limited to the present embodiment, and modifications and improvements thereto within the scope that can realize the object of the present invention are included in the present invention.

For example, although it has been described that the surface of the clock object 31 displayed in the digital photo frame 1 is a flat surface without irregularity in the present embodiment, the present invention is not limited to such an example. The clock object 31 can be configured as a 3D object of any three-dimensional shape according to the implementation.

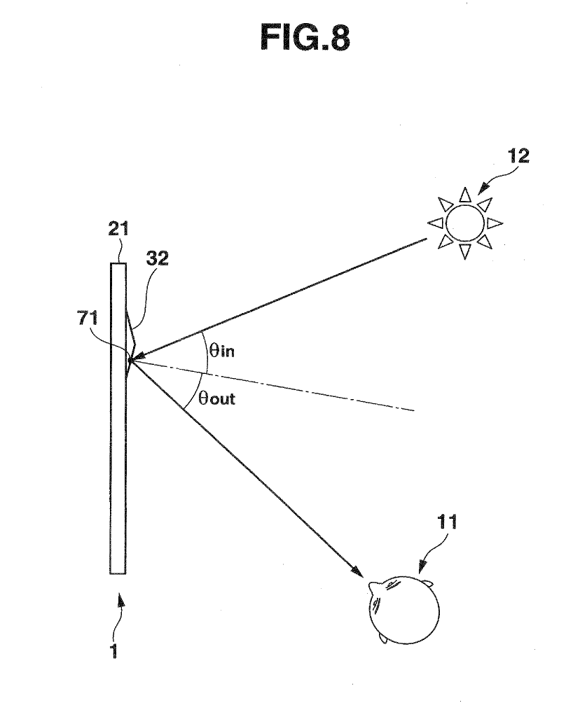

For example, as shown in FIG. 8, the long hand 32 of the clock object 31 can be configured as a 3D object having a cross-section perpendicular to the surface viewed from the viewer 11 that is triangular. In other words, the surface of the long hand 32 viewed from the viewer 11 can be sloped toward either side from a central portion. In this case, the reflection area detecting unit 57 shown in FIG. 2 obtains the estimated incident angle θin of the light entering from the light source 12 and the reflection angle θout (=the incident angle θin) for the areas representing the long hand 32 out of the display image, by considering a slope angle of the surface of the long hand 32. Then, in a case of there being an area in which the face light source angle θα is substantially twice as large as the reflection angle θout (the angle substantially equal to the incident angle θin+the reflection angle θout) among the areas representing the long hand 32, for example, the reflection area detecting unit 57 detects this area as the reflection area. At this time, the face light source angle θα can be corrected by considering the slope angle of the surface of the long hand 32.

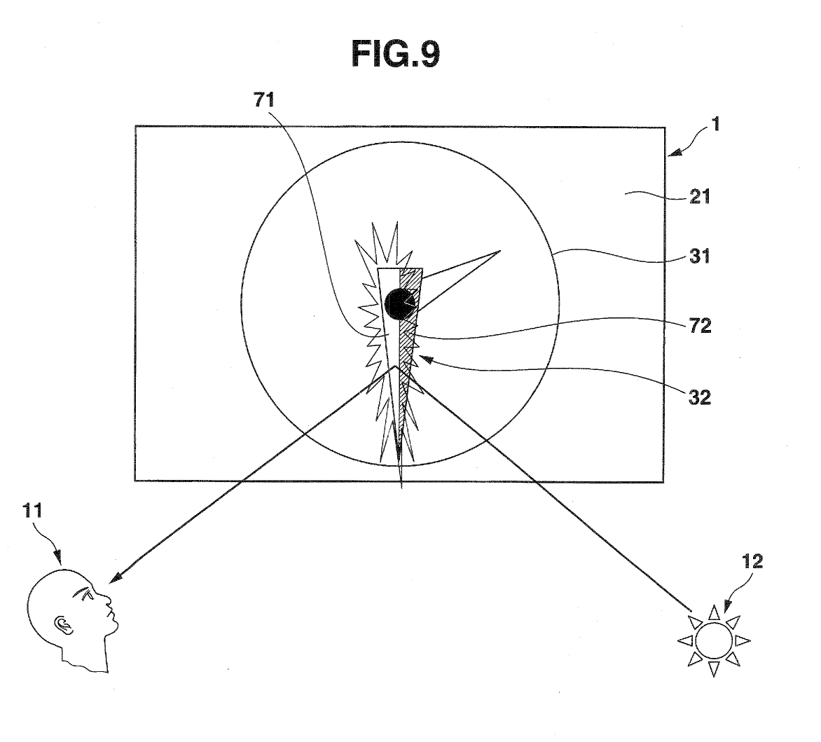

In the example shown in FIG. 8, an area 71 of one of the sloped surfaces of the long hand 32 of the clock object 31 is detected as the reflection area. In this case, as shown in FIG. 9, since the area 71 of the sloped surface toward the side of the viewer 11 from the central portion (the sloped surface on the left side in FIG. 9) among the areas representing the long hand 32 of the clock object 31 is detected as the reflection area, an area 72 of the sloped surface on the opposite side (the sloped surface on the right side in FIG. 9), for example, is detected as the shaded area. As a result, as shown in FIG. 9, the reflection effect is added to the area 71 of the long hand 32. Accordingly, the viewer 11 is able to see the appearance in which it is as if the light were reflecting on the area 71. On the other hand, the shading effect is added to the area 72 of the long hand 32. Accordingly, the viewer 11 is able to see the appearance in which it is as if the shading were present at the area 72. In this manner, an image that is more realistic and more natural for the viewer 11 is displayed in the display unit 21 as the display image.

For example, although it has been described that the reflection effect or the shading effect is added only to the hand of the clock object 31 in the present embodiment, the present invention is not limited to such an example. For example, the reflection effect or the shading effect may be entirely added to the clock object 31. In this case, the area in which the face light source angle θα is substantially twice as large as the reflection angle θout (the angle substantially equal to the incident angle θin+the reflection angle θout) among the areas that constitute the clock object 31, including an area other than the hand such as a clock face is set as the reflection area. The shaded area can also be determined according to the reflection area. Furthermore, in a case of visually distinguishing the hand from the area such as the clock face excluding the hand, for example, it is possible to change the brightness by varying reflection ratios respectively of the hand and the clock face, and the image display apparatus executing the image processing of adding the reflection effect in which the reflection ratios have been considered.

It should be noted that, in the present embodiment, although taking the image including the clock object 31 as the example of the display image to which the effect of presentation is added has been described for ease of explanation, the present invention is not limited to such an example. In other words, the object included in the display image to which the effect of presentation is added is not particularly limited to the clock object 31, and can be any object regardless of being 2D or 3D.

Furthermore, in the present embodiment, although it has been described that the digital photo frame 1 uses the virtual light source and the actual light source selectively as the light source 12, the present invention is not limited to such an example. For example, it is possible to apply the present invention also by fixing and using only one of the virtual light source and the actual light source. With this, in the case in which only the virtual light source is used, for example, it is possible to omit the luminance measuring unit 54 shown in FIG. 2. Similarly, in the case in which only the actual light source is used, for example, there is no particular need for storing the virtual light source data shown in FIG. 2 in the data storing unit 51.

In the present embodiment, although the digital photo frame 1 is able to execute the image processing of adding both the reflection effect and the shading effect as described with reference to FIG. 9 and such, the present invention is not limited to such an example. For example, the present invention can be applied to image processing of adding only one of the reflection effect and the shading effect. Alternatively, the present invention can be applied to image processing of adding at least one of the reflection effect and the shading effect in combination with any other image processing.

Furthermore, in the present embodiment, although the face detecting unit 52 to the display control unit 59 of the digital photo frame 1 shown in FIG. 2 are configured as a combination of software and hardware (the CPU 101), this configuration is merely an example. For example, each of the face detecting unit 52 to the display control unit 59 shown in FIG. 2 can be configured by dedicated hardware or software depending on the implementation.

Incidentally, the series of processing according to the present invention can be executed by hardware and also can be executed by software.

In a case in which the series of processing is to be executed by software, the program configuring the software is installed from a network or a storage medium in a computer or the like. The computer may be a computer incorporated in exclusive hardware. Alternatively, the computer may be a computer capable of executing various functions by installing various programs, i.e. a general-purpose personal computer, for example.

Although not illustrated, the storage medium containing the program can be constituted not only by removable media distributed separately from the device main body for supplying the program to a user, but also by a storage medium or the like supplied to the user in a state incorporated in the device main body in advance. The removable media is composed of a magnetic disk (including a floppy disk), an optical disk, a magnetic optical disk, or the like, for example. The optical disk is composed of a CD-ROM (Compact Disk-Read Only Memory), a DVD (Digital Versatile Disk), and the like. The magnetic optical disk is composed of an MD (Mini-Disk) or the like. The storage medium supplied to the user in the state incorporated in the device main body in advance includes the ROM 102 in FIG. 6 storing the program, a hard disk, not illustrated, and the like, for example.

It should be noted that, in the present description, the step describing the program stored in the storage medium includes not only the processing executed in a time series following this order, but also processing executed in parallel or individually, which is not necessarily executed in a time series.

What is claimed is:

1. An image display apparatus comprising:
an image capturing unit that captures an image of a viewer viewing a display image displayed in a display unit;
a face detecting unit that detects a face from the image captured by the image capturing unit;
a face position determining unit that determines a position of the face detected by the face detecting unit;
a light source position determining unit that determines a position of a light source;
a reflection area detecting unit that detects a reflection area from the display image based on the position of the face determined by the face position determining unit and the position of the light source determined by the light source position determining unit, the reflection area being an area in which light incident from the light source is reflected toward the face;
a reflection effect processing unit that executes, on data of the display image, the image processing of adding a reflection effect to the reflection area detected by the reflection area detecting unit; and
a display control unit that causes the display unit to display the display image based on the data on which the image processing has been executed by the reflection effect processing unit.

2. An image display apparatus as set forth in claim 1, wherein the light source is
a virtual light source, and
wherein the light source position determining unit determines a position of the virtual light source based on the position of the face.

3. An image display apparatus as set forth in claim 1,
wherein the light source is an actual light source,
wherein the image display apparatus further comprises a luminance measuring unit that measures a luminance distribution of the image captured by the image capturing unit, and
wherein the light source position determining unit determines a position of the actual light source based on a measurement result of the luminance measuring unit.

4. An image display apparatus as set forth in claim 1,
wherein the reflection area detecting unit further detects from the display image a shaded area in which shading is present, and
wherein the reflection effect processing unit further executes, on the data of the display image, image processing of adding a shading effect to the shaded area detected by the reflection area detecting unit.

5. An image display apparatus as set forth in claim 1,
wherein, in a case in which a plurality of faces is detected by the detecting unit, the face position determining unit sets a predetermined one of the plurality of faces as a face-to-be-processed and determines a position of the face-to-be-processed.

6. An image display apparatus as set forth in claim 1,
Wherein, in a case in which no faces are detected by the detecting unit, the reflection effect processing unit prohibits the execution of the image processing.

7. An image display method comprising:
an image capturing control step of controlling image capturing to capture an image of a viewer viewing a display image displayed in a display unit;
a face detecting step of detecting a face from the image captured in the image capturing control step;
a face position determining step of determining a position of the face detected in the face detecting step;
a light source position determining step of determining a position of a light source;
a reflection area detecting step of detecting a reflection area from the display image based on the position of the face determined in the face position determining step and the position of the light source determined in the light source position determining step, the reflection area being an area in which light incident from the light source is reflected toward the face;
a reflection effect processing step of executing, on data of the display image, image processing of adding a reflection effect to the reflection area detected in the reflection area detecting step; and
a display control step of causing the display unit to display the display image based on the data on which the image processing has been executed in the reflection effect processing step.

8. A storage medium storing a program readable by a computer for controlling image processing to cause the computer to execute a control process, comprising:
an image capturing control step of controlling image capturing to capture an image of a viewer viewing a display image displayed in a display unit;
a face detecting step of detecting a face from the image captured in the image capturing control step;
a face position determining step of determining a position of the face detected in the face detecting step;
a light source position determining step of determining a position of a light source;
a reflection area detecting step of detecting a reflection area from the display image based on the position of the face determined in the face position determining step and the position of the light source determined in the light source position determining step, the reflection area being an area in which light incident from the light source is reflected toward the face;
a reflection effect processing step of executing, on data of the display image, image processing of adding a reflection effect to the reflection area detected in the reflection area detecting step; and
a display control step of causing the display unit to display the display image based on the data on which the image processing has been executed in the reflection effect processing step.
